(19) United States
(12) Patent Application Publication
(10) Pub. No.: US 2026/0084183 A1
(43) Pub. Date: Mar. 26, 2026

(54) MULTI-LAYER COATING FOR STAIN PROTECTION AND STAIN RELEASE

(71) Applicant: WE Group, LLC, Southlake, TX (US)

(72) Inventors: Steven Wright ENGLISH, Trophy Club, TX (US); Charles Gregory HADFIELD, Port Charlotte, FL (US); Harrison Markus JAMES, Northlake, TX (US)

(21) Appl. No.: 19/191,946

(22) Filed: Apr. 28, 2025

Related U.S. Application Data
(60) Provisional application No. 63/697,113, filed on Sep. 20, 2024.

(51) Int. Cl. B05D 7/00; B05D 5/08; D06N 3/00; D06N 3/12; D06N 7/00

(52) U.S. Cl. CPC B05D 7/544; B05D 5/08; D06N 3/0059; D06N 3/0063; D06N 3/12; D06N 7/0094; B05D 2425/01; B05D 2425/02; D06N 2209/141; D06N 2209/142; D10B 2401/021; D10B 2401/022

(57) ABSTRACT

Implementations of the present disclosure generally relate to coatings for textiles and other substrates. In one or more implementation, methods for forming a protective coating on a substrate are provided and include depositing a hydrophobic base coating on at least one of a first or second surface of the substrate to form a first coated substrate, where the hydrophobic base coating is free of fluorocarbon compounds. The method further includes drying the first coated substrate by air-drying in ambient conditions or by heating the first coated substrate and depositing a hydrophilic top coating onto the hydrophobic base coating.

### CROSS-REFERENCE TO RELATED APPLICATIONS

This application claims benefit of U.S. Provisional patent application Ser. No. 63/697,113, filed Sep. 20, 2024, which is herein incorporated by reference in its entirety.

### BACKGROUND

### Field

The present disclosure generally relates to coatings for textiles and other substrates, and more particularly, to per-and polyfluoroalkyl substance free protective coatings.

### Description of the Related Art

Characteristics such as water repellency, oil repellency, stain resistance, and stain release are highly desirable to facilitate cleaning of substrates. Conventional methods of imparting these characteristics on substrates involve coating substrates with materials containing per-and polyfluoroalkyl substances (PFAS). PFAS have hydrophobic and oleophobic properties that provide an effective barrier against water, oil, and grease. However, PFAS, sometimes referred to as forever chemicals, are slow to break down which leads to a build-up in people, animals, and the environment. PFAS have been linked to adverse health outcomes, such as developmental delays, increased risk of cancers, reduced immune system activity, and increased cholesterol. Alternative coatings, that do not contain PFAS, do not meet commercial demand for water repellency, oil repellency, stain resistance, and stain release.

Therefore, there is a need for PFAS free coatings and methods for forming PFAS free coatings that have high water repellency, oil repellency or oil stain release, stain resistance, and stain release characteristics.

### SUMMARY

Implementations of the present disclosure generally relate to coatings for textiles and other substrates. More particularly, implementations described herein provide one or more protective coatings and methods for forming the protective coatings without the use of PFAS.

In at least one implementation, a method for forming a protective coating, is provided and includes providing a substrate, the substrate having a first surface and a second surface, and depositing a hydrophobic base coating on at least one of the first surface or the second surface of the substrate to form a first coated substrate, where the hydrophobic base coating is free of fluorocarbon compounds. The method further includes heating the first coated substrate and depositing a hydrophilic top coating onto the hydrophobic base coating.

In at least one implementation, a method for forming a protective coating, is provided and includes providing a substrate, the substrate having a first surface and a second surface, and depositing a hydrophobic base coating on at least one of the first surface or the second surface of the substrate to form a first coated substrate, where the hydrophobic base coating is free of fluorocarbon compounds. The method further includes drying the first coated substrate by air-drying in ambient conditions or by heating the first coated substrate, and depositing a hydrophilic top coating onto the hydrophobic base coating.

In at least one implementation, a method for forming a protective coating is provided and includes applying a hydrophobic base coating, the hydrophobic base coating including one or more of a hyperbranched polymer and a comb-polymer, where the hydrophobic base coating is applied using a bath coating process, a kiss coating process, or a spray coating process. The method further includes applying a hydrophilic top coating onto the hydrophobic base coating. The hydrophilic top coating includes one or more of a metal oxide, a metal phosphate complex, a metal hydroxy phosphate complex, a metal phosphonate complex, a metal hydroxy phosphonate complex, a metal thiophosphonate complex, a metal sulfonate complex, a metal hydroxy sulfonate complex, or any combination thereof.

In at least one implementation, a protective coating is provided and includes a hydrophilic top coating disposed on a hydrophobic base coating. The hydrophobic base coating includes one or more of a hyperbranched polymer and a comb-polymer and the hydrophobic base coating is free of fluorocarbon compounds. The hydrophilic top coating is free of fluorocarbon compounds.

### BRIEF DESCRIPTION OF THE DRAWINGS

So that the manner in which the above recited features of the disclosure can be understood in detail, a more particular description of the disclosure, briefly summarized above, may be had by reference to implementations, some of which are illustrated in the appended drawings. It is to be noted, however, that the appended drawings illustrate only typical implementations of this disclosure and are therefore not to be considered limiting of scope, for the disclosure may admit to other equally effective implementations.

FIG. 1 depicts a cross-sectional view of a coated substrate according to one or more implementations described herein.

FIG. 2 is a flow diagram of a method of forming a multi-layer protective coating, according to one or more implementations described herein.

To facilitate understanding, identical reference numerals have been used, where possible, to designate identical elements that are common to the Figures. It is contemplated that elements and features of one implementation may be beneficially incorporated in other implementations without further recitation.

### DETAILED DESCRIPTION

Implementations of the present disclosure generally relate to coatings for textiles and other substrates. More particularly, implementations described herein provide protective coatings and methods for forming the protective coatings without the use of per-and polyfluoroalkyl substances (PFAS). It has been discovered that a multi-layer protective coating, including a hydrophobic base coating and a hydrophilic top coating, can be applied to a variety of substrates to impart improved stain and/or oil resistance, repellency and release. The multi-layer protective coatings described herein are free of PFAS.

### Multi-Layer Protective Coating

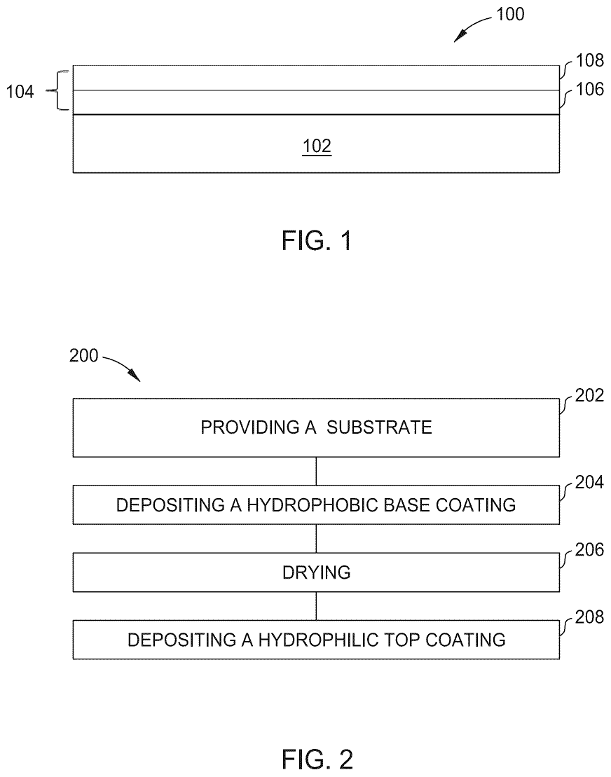

FIG. 1 depicts a cross-sectional view of a coated substrate according to one or more implementations described herein. The coated substrate 100 includes the substrate 102 and the protective coating 104. The protective coating 104 contains a hydrophilic top coating 108 disposed on a hydrophobic base coating 106. In one or more implementations, the protective layer contains two sub-coatings, the hydrophobic base coating 106 disposed on the substrate 102, and the hydrophilic top coating 108 disposed on the hydrophobic base coating 106.

In some implementations, the protective coating 104 is disposed on one side of the substrate 102, as shown in FIG. 1. In other implementations, the protective coating 104 is disposed on both sides of the substrate 102 (not shown). In further implementations, the protective coating 104 may also be embedded in the substrate 102. For example, a fibrous textile substrate, such as substrate 102, may be coated on both sides such that the protective coating 104 coats the textile fibers and at least partially fills the voids between the textile fibers.

The hydrophilic top coating 108 is disposed on the hydrophobic base coating 106. In some implementations, the hydrophilic top coating 108 completely covers the hydrophobic base coating 106 disposed on the substrate 102, as shown in FIG. 1. In other implementations the hydrophilic top coating 108 partially covers the hydrophobic base coating 106 disposed on the substrate 102 (not shown).

In at least some implementations, the protective coating 104 improves the stain resistance and release of the substrate 102. The combination of the hydrophobic base coating 106 and the hydrophilic top coating 108 impart high water repellency, oil repellency and/or oil stain release, stain resistance, and stain release characteristics to the substrate 102. In at least some implementations, the hydrophobic base coating 106 provides a barrier preventing hydrophilic stains, such as water based stains and/or staining compounds dissolved in water, from coming into contact with and/or penetrating the surface of the substrate 102. In at least some implementations, the hydrophilic top coating 108 improves the efficiency of stain release from the substrate 102. In at least some implementations, the hydrophilic top coating 108 aids in the stain release of hydrophobic stains, such as oil based stains and/or substances containing oils or other hydrocarbon containing compounds. For example, in at least some implementations, the substrate 102 may be a textile having the protective coating 104 disposed thereon, and the textile may readily release oil and/or grease stains when washed using conventional methods. In at least some implementations, the hydrophilic top coating 108 allows a thin film of water to form over the coated surface of the substrate 102 instead of discrete water droplets that may otherwise form on hydrophobic surfaces, such as the hydrophobic base coating 106. In at least some implementations, the thin film of water may be maintained on the coated surface of the substrate 102 during washing, allowing hydrophobic/hydrophilic interactions between any hydrophobic stains and the thin film of water, resulting in the release of the hydrophobic stains from the substrate 102.

In at least some implementations, the hydrophilic top coating 108 includes polar functional groups, such as hydroxyl (—OH), amino (—NH₂), carbonyl (C═O), and/or carboxyl (—COOH) groups. The polar functional groups have regions of partial positive and negative charges that create a polar surface. The polar surface interacts strongly with water molecules through hydrogen bonding, resulting in a superhydrophilic (extremely water-attracting) surface, where water forms a uniform thin film instead of discrete droplets. In at least some implementations, the formation of a uniform thin film of water over the coated surface of the substrate 102 may additionally or otherwise be aided by dipole-dipole interactions and/or ion-dipole interactions between the hydrophilic top coating 108 and water.

In some implementations, which can be combined with other implementations, the substrate 102 is any suitable soft or hard material that is prone to staining, such as textiles, tiles, or ceramics. Examples of textiles include, but are not limited to, woven fabrics, nonwoven fabrics, carpets, screens, or any combination thereof. Examples of tiles include, but are not limited to, porous tiles, non-porous tiles, tiles made of natural stone (e.g., granite, marble, travertine), or any combination thereof.

The hydrophobic base coating 106 is substantially free and/or free of halogen compounds and is free of fluorocarbon compounds. For example, the hydrophobic base coating 106 may contain less than 1 part per billion (ppb) of halogen compounds, such as less than 0.01 ppb, or 0 ppb and the hydrophobic base coating 106 may contain less than 0.01 part per trillion (ppt) of fluorocarbon compounds or 0 ppt of fluorocarbon compounds. In some implementations, which can be combined with other implementations, the hydrophobic base coating 106 may include silane coatings, silica nanoparticle coatings, polymeric coatings, wax coatings, biomimetic coating, sol-gel coatings, ceramic coatings, graphene coatings, carbon nanotube coatings, metal oxide coatings, alkyl ketene dimer (AKD) coatings, natural and bio coatings, advanced material coatings, sustainable coatings, smart coatings, or composite coatings that are suitably hydrophobic. A suitably hydrophobic coating has a water contact angle greater than 90°.

Examples of polymeric coatings may be or include, but are not limited to, hydrophobic polymers, polydimethylsiloxane (PDMS) coatings, Zwitterionic polymer coatings, silicone coatings, polyurethane coatings, epoxy resin coatings, polypropylene coatings, polyethylene coatings, acrylic coatings, polyimide coatings, polyester coatings, polyamide coatings, polysulfone coatings, polyketone coatings. In some implementations, the polymeric coating may be a hyperbranched polymer, a comb polymer, or combinations thereof.

Examples of natural and bio coatings may be or include, but are not limited to, natural oils and waxes, cellulose coatings, cellulose nanofiber coatings, chitosan coatings, biopolymer coatings, starch coatings, soy protein isolate coatings, gelatin coatings, casein coatings, whey protein coatings, corn zein coatings, rice protein coatings, collagen coatings, elastin coatings, alginate coatings, agar coatings, carrageenan coatings, pectin coatings, chitin coatings, lignin coatings, tannin coatings, gum arabic coatings, guar gum coatings, locust bean gum coatings, xanthan gum coatings.

Hydrophobic advanced material coatings may be or include graphene coatings, carbon nanotube coatings, polyhedral oligomeric silsesquioxane (POSS) coatings, metal-organic frameworks (MOFs), zeolite coatings, mesoporous silica coatings, and covalent organic frameworks (COFs). Hydrophobic sustainable coatings may be or include bio hydrophobic coatings, solvent-free hydrophobic coatings, recyclable hydrophobic coatings, biodegradable hydrophobic coatings, or any combination thereof. Hydrophobic smart coatings may be or include stimuli-responsive coatings, antifouling coatings, antistatic coatings, light-absorbing coatings, magnetic coatings, coatings with shape memory polymers, electrically conductive coatings, coatings with variable transparency that are suitably hydrophobic, or any combination thereof. Hydrophobic composite coatings may be or include graphene-polymer composites, carbon nanotube-polymer composites, nanoclay-polymer composites, metal oxide-polymer composites, organic-inorganic hybrid coatings, or any combination thereof.

In some implementations, which can be combined with other implementations, the hydrophobic base coating 106 includes at least a functionalized polymer and propylene glycol. The functionalized polymer may be a hyperbranched polymer, a comb polymer, or combinations thereof. In some implementations, which can be combined with other implementations, the hydrophobic base coating 106 may include cationic surfactants, paraffin waxes, hydrocarbon waxes, or combinations thereof. The hydrophobic base coating 106 may include about 0.5% to about 1% cationic surfactants, such as about 0.5% to about 0.9%, about 0.6% to about 0.8%, or about 0.6% to about 1%. The hydrophobic base coating 106 may include about 5% to about 15% paraffin waxes and/or hydrocarbon waxes, such as about 5% to about 10%, about 7% to about 14%, about 6% to about 12%, or about 10% to about 15%. In some implementations, the hydrophobic base coating 106 has a wet pick up of about 30% to about 80%, such as about 30% to about 60% or about 60% to about 80%. A wet pick up is defined as the amount of fluid by percent weight picked up by a fiber during an application process.

The hydrophilic top coating 108 is substantially free and/or free of halogen compounds and is free of fluorocarbon compounds. For example, the hydrophilic top coating 108 may contain less than 1 ppb of halogen compounds, such as less than 0.01 ppb, or 0 ppb and the hydrophilic top coating 108 may contain less than 0.01 ppt of fluorocarbon compounds or 0 ppt of fluorocarbon compounds. In some implementations, which can be combined with other implementations, the hydrophilic top coating may include silane coatings, silica nanoparticle coatings, polysaccharide coatings, polymeric coatings, natural and bio coatings, advanced material coatings, sustainable coatings, smart coatings, or composite coatings that are suitably hydrophilic. A suitably hydrophilic coating has a water contact angle less than 90°.

Examples of hydrophilic polymeric coatings include, but are not limited to, polyethylene glycol (PEG) coatings, polyvinyl alcohol (PVA) coating, polyacrylic acid (PAA) coatings, hydrophilic polymer blends, zwitterionic polymer coatings, hydrophilic polyurethane coatings, hydrophilic silicone coatings, hydrophilic epoxy resin coatings, polydopamine coatings, hydrophilic copolymers, hydrophilic monomers and oligomers, or any combination thereof.

Examples of natural and bio coatings may be or include, but are not limited to, cellulose coatings, chitosan coatings, alginate coatings, agar coatings, carrageenan coatings, pectin coatings, starch coatings, protein coatings, biopolymer coatings, lignin coatings, and tannin coatings.

Hydrophilic advanced material coatings may be or include hydrophilic graphene coatings, carbon nanotube coatings, metal oxide coatings such as titanium oxide (TiO₂), or zinc oxide (ZnO), polyhedral oligomeric silsesquioxane (POSS) coatings, metal-organic frameworks (MOFs), zeolite coatings, mesoporous silica coatings, covalent organic frameworks (COFs), or any combination thereof. Hydrophilic sustainable coatings may be or include bio hydrophilic coatings, solvent-free coatings, recyclable hydrophilic coatings, biodegradable hydrophilic coatings, or any combination thereof. Hydrophilic smart coating may be or include stimuli-responsive coatings, antifouling coatings, antistatic coatings, light-absorbing coatings, magnetic coatings, coatings with shape memory polymers, electrically conductive coatings, coatings with variable transparency, or any combination thereof. Hydrophilic composite coatings may be or include graphene-polymer composites, carbon nanotube-polymer composites, nanoclay-polymer composites, metal oxide-polymer composites, organic-inorganic hybrid coatings, or any combination thereof.

Any of the previously mentioned hydrophilic coatings may be functionalized with hydrophilic groups. Hydrophilic groups include, but are not limited to, hydroxyl, carbonyl, carboxyl, amino, sulfhydryl, phosphate, phosphonate, hydroxyl phosphate groups, or any combination thereof. In at least some implementations, the hydrophilic groups may advantageously aid in stain release from the substrate 102, as the hydrophilic groups aid in the formation of a thin film of water instead of discrete droplets of water on the coated surface of the substrate 102.

In some implementations, which can be combined with other implementations, the hydrophilic top coating includes a metal phosphate complex, a metal hydroxy phosphate complex, a metal phosphonate complex, a metal hydroxy phosphonate complex, a metal thiophosphonate complex, a metal sulfonate complex, a metal hydroxy sulfonate complex, or combinations thereof. For example, in at least one implementation, the hydrophilic top coating includes a titanium hydroxy phosphate complex.

### Method

FIG. 2 is a schematic block diagram of a method 200 of forming a multi-layer protective coating, according to one or more implementations described herein. Method 200 is detailed below in reference to the implementations shown in FIG. 1. However, method 200 may be used to form multiple protective coatings in other implementations.

Operation 202 includes providing a substrate, such as substrate 102, to be coated.

Operation 204 includes depositing the hydrophobic base coating 106 onto the substrate 102. The hydrophobic base coating may be deposited using a bath coating process, a kiss coating process, or a spray coating process. The spray coating process may include a thermal spraying process, a cold spraying process, or an electrospray deposition.

In some implementations, which can be combined with other implementations, other coating methods may be used. Examples of suitable coating methods include, but are not limited to, hot-dip coating, roll-to-roll coating, dip coating, spin coating, doctor blade coating, curtain coating, brush coating, or any combination thereof.

In some implementations, which can be combined with other implementations, other deposition, printing, and lithography techniques may be used to deposit the hydrophobic base coating. Examples of deposition techniques include, but are not limited to, Atomic Layer Deposition (ALD), Chemical Vapor Deposition (CVD), Physical Vapor Deposition (PVD), Plasma-Enhanced Chemical Vapor Deposition (PECVD), Laser-Assisted Chemical Vapor Deposition (LACVD), Magnetron Sputtering, Aerosol-Assisted Chemical Vapor Deposition (AACVD), and Ion Beam Deposition. Examples of printing and lithography techniques include, but are not limited to, screen printing, inkjet printing, microcontact printing, soft lithography, photolithography, nanoimprint lithography, and dip-pen nanolithography.

Operation 206 includes drying the coated substrate containing the hydrophobic base coating 106. In some implementations, which can be combined with other implementations, the coated substrate is dried by heating the coated substrate. The coated substrate is heated to a temperature of about 50 degrees Celsius to about 200 degrees Celsius, such as about 100 degrees Celsius to about 175 degrees Celsius, about 50 degrees Celsius to about 150 degrees Celsius, about 50 degrees Celsius to about 100 degrees Celsius, or about 150 degrees Celsius to about 175 degrees Celsius. The heat treatment anneals the hydrophobic base coating and dries any solvents used during the deposition of the hydrophobic base coating. The coated substrate containing the hydrophobic base coating 106 may be heated for about 1 second(s) to about 2 hours, such as about 1 s to about 1 minute, about 1 minute to about 5 minutes, about 5 minute to about 20 minutes about 1 minute to about 50 minutes, about 10 minutes to about 30 minutes, about 20 minute to about 1 hour, or about 30 minutes to about 2 hours. The coated substrate containing the hydrophobic base coating 106 may be heated at standard atmospheric pressure.

In some implementations, which can be combined with other implementations, the coated substrate is air-dried in ambient conditions, for example room temperature (e.g., about 20 degrees Celsius to about 25 degrees Celsius) and standard atmospheric pressure. The coated substrate containing the hydrophobic base coating 106 may be air-dried in ambient conditions for about 1 minute to about 24 hours, such as about 10 minutes to about 24 hours, about 30 minutes to about 24 hours, about 1 hour to about 24 hours, about 2 hours to about 24 hours, about 5 hours to about 24 hours, about 10 hours to about 24 hours, about 1 hour to about 10 hours or about 1 minute to about 1 hour.

Operation 208 includes depositing the hydrophilic top coating 108 onto the hydrophobic base coating 106. The hydrophilic top coating may be deposited using a bath coating process, a kiss coating process, or a spray coating process. The spray coating process may include a thermal spraying process, a cold spraying process, or an electrospray deposition.

In some implementations, which can be combined with other implementations, other coating methods may be used. Examples of suitable coating methods include, but are not limited to, hot-dip coating, roll-to-roll coating, dip coating, spin coating, doctor blade coating, curtain coating, brush coating, or any combination thereof.

In some implementations, which can be combined with other implementations, other deposition, printing and lithography techniques may be used to deposit the hydrophilic top coating. Examples of deposition techniques include, but are not limited to, Atomic Layer Deposition (ALD), Chemical Vapor Deposition (CVD), Physical Vapor Deposition (PVD), Plasma-Enhanced Chemical Vapor Deposition (PECVD), Laser-Assisted Chemical Vapor Deposition (LACVD), Magnetron Sputtering, Aerosol-Assisted Chemical Vapor Deposition (AACVD), and Ion Beam Deposition. Examples of printing and lithography techniques include, but are not limited to, screen printing, inkjet printing, microcontact printing, soft lithography, photolithography, nanoimprint lithography, and dip-pen nanolithography.

Overall, the multi-layer protective coatings and methods of the present disclosure can reduce or prevent staining of a substrate by utilizing the combined characteristic of a hydrophobic base coating and a hydrophilic top coating. The combination of the hydrophobic base coating and the hydrophilic top coating impart high water repellency, oil repellency and/or oil stain release, stain resistance, and stain release characteristics to the substrate. The hydrophobic base coating acts a barrier for the substrate while the hydrophilic top coating aids in releasing the stain. The combination of the hydrophobic base coating and the hydrophilic top coating in the multi-layer protective coating imparts improved stain and/or oil resistance, repellency and release without the use of per-and polyfluoroalkyl substances.

While the foregoing is directed to implementations of the present disclosure, other and further implementations of the disclosure may be devised without departing from the basic scope thereof. The present disclosure also contemplates that one or more aspects of the implementations described herein may be substituted in for one or more of the other aspects described. The scope of the disclosure is determined by the claims that follow.

Certain implementations and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below.

What is claimed is:

1. A method for forming a protective coating, comprising:
providing a substrate having a first surface and a second surface;
depositing a hydrophobic base coating on at least one of the first surface or the second surface of the substrate to form a first coated substrate, wherein the hydrophobic base coating is free of fluorocarbon compounds;
drying the first coated substrate by air-drying in ambient conditions or by heating the first coated substrate; and
depositing a hydrophilic top coating onto the hydrophobic base coating.

2. The method of claim 1, wherein the hydrophilic top coating is free of fluorocarbon compounds.

3. The method of claim 1, wherein the hydrophobic base coating comprises one or more hydrophobic polymers selected from the group consisting of polydimethylsiloxane (PDMS) polymers, Zwitterionic polymers, silicone polymers, polyurethane polymers, epoxy polymers, polypropylene polymers, polyethylene polymers, acrylic polymers, polyimide polymers, polyester polymers, polyamide polymers, polysulfone polymers, polyketone polymers, and any combination thereof.

4. The method of claim 3, wherein the hydrophobic polymers are hyperbranched polymers, comb-polymers, or combinations thereof.

5. The method of claim 1, wherein the first coated substrate is dried by heating the first coated substrate to a temperature of about 50 degrees Celsius to about 200 degrees Celsius.

6. The method of claim 1, wherein the first coated substrate is air-dried in ambient conditions.

7. The method of claim 1, wherein the hydrophilic top coating is selected from the group consisting of a metal oxide, a metal phosphate complex, a metal hydroxy phosphate complex, a metal phosphonate complex, a metal hydroxy phosphonate complex, a metal thiophosphonate complex, a metal sulfonate complex, a metal hydroxy sulfonate complex, and combinations thereof.

8. The method of claim 7, wherein the hydrophilic top coating comprises a titanium hydroxy phosphate complex.

9. The method of claim 1, wherein the substrate comprises a textile, a tile, or a ceramic.

10. The method of claim 1, wherein the substrate comprises a textile.

11. The method of claim 1, wherein the hydrophobic base coating is deposited via a bath coating process, a kiss coating process, or spray coating process.

12. A method for forming a protective coating, comprising:
applying a hydrophobic base coating, the hydrophobic base coating comprising one or more of a hyperbranched polymer and a comb-polymer, wherein the hydrophobic base coating is applied using a bath coating process, a kiss coating process, or spray coating process;
and
applying a hydrophilic top coating onto the hydrophobic base coating, the hydrophilic top coating comprising one or more of a metal oxide, a metal phosphate complex, a metal hydroxy phosphate complex, a metal phosphonate complex, a metal hydroxy phosphonate complex, a metal thiophosphonate complex, a metal sulfonate complex, a metal hydroxy sulfonate complex, and any combination thereof.

13. The method of claim 12, wherein the hydrophobic base coating and the hydrophilic top coating are free of fluorocarbon compounds.

14. The method of claim 12, wherein the hydrophilic top coating comprises a titanium hydroxy phosphate complex.

15. The method of claim 12, wherein the hyperbranched polymer or the comb-polymer comprises one or more hydrophobic polymers selected from the group consisting of polydimethylsiloxane (PDMS) polymers, Zwitterionic polymers, silicone polymers, polyurethane polymers, epoxy polymers, polypropylene polymers, polyethylene polymers, acrylic polymers, polyimide polymers, polyester polymers, polyamide polymers, polysulfone polymers, polyketone polymers, and any combination thereof.

16. The method of claim 12, wherein the hydrophilic top coating is applied using a bath coating process, a kiss coating process, or a spray coating process.

17. The method of claim 12, further comprising heating the applied hydrophobic base coating to a temperature of about 50 degrees Celsius to about 200 degrees Celsius.

18. A protective coating comprising:
a hydrophobic base coating comprising one or more of a hyperbranched polymer and a comb-polymer, wherein the hydrophobic base coating is free of fluorocarbon compounds; and
a hydrophilic top coating disposed on the hydrophobic base coating, wherein the hydrophilic top coating is free of fluorocarbon compounds.

19. The protective coating of claim 18, wherein the hyperbranched polymer, or the comb-polymer comprise one or more hydrophobic polymers selected from the group consisting of polydimethylsiloxane (PDMS) polymers, Zwitterionic polymers, silicone polymers, polyurethane polymers, epoxy polymers, polypropylene polymers, polyethylene polymers, acrylic polymers, polyimide polymers, polyester polymers, polyamide polymers, polysulfone polymers, polyketone polymers, and any combination thereof.

20. The protective coating of claim 18, wherein the hydrophilic top coating comprises a titanium hydroxy phosphate complex.
